(19) United States
(12) Patent Application Publication
(10) Pub. No.: US 2008/0028941 A1
(43) Pub. Date: Feb. 7, 2008

(54) Machine to make tea and coffee immediately with cup and holder in a car

(76) Inventor: Tenzing Kunga, Somerville, MA (US)

Correspondence Address: Tenzing Kunga, 13 Harrison Street, Somerville, MA, 02143, US

(21) Appl. No.: 11/466,055

(22) Filed: Aug. 21, 2006

Related U.S. Application Data
(60) Provisional application No. 60/821,375, filed on Aug. 3, 2006.

(51) Int. Cl. A23L 1/00

(52) U.S. Cl. 99/275

(57) ABSTRACT

This invention will not make a person stop at a coffee shop before going to work. It will also act as a comfort for a person to drink tea and coffee after work on the way home. This machine may also serve ice-creams and cappuccinos.

A cold water vessel that heats automatically when a button is clicked by remote or manually. This cold water when heated to a certain temperature will enter another portion of the machine which will also include tea bags, coffee powder and a little sugar and cream pushed by another section of the machine. The sugar and cream can be blocked by remote or manually by just pushing a sugar block or cream block button. Once in the vessel all ingredient components will mix for a certain time until it is ready and then the tea bag will be discarded in a section which can be opened and cleaned. While the tea will be pushed to a cup through a pipe, this cup will also have a cup holder which will be beneath before but will slowly immerse upwards within easy reach of the driver.

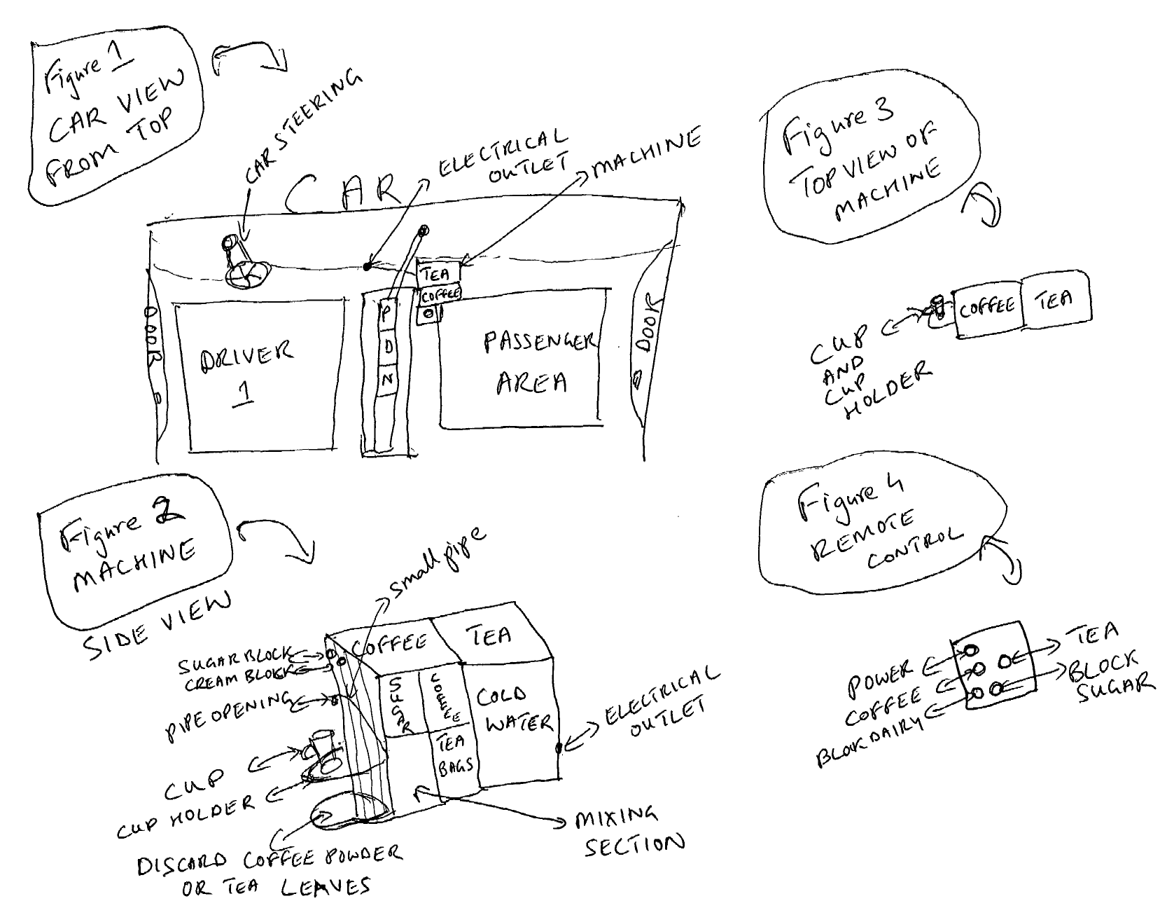

The components work together with the electrical outlet connected to the car or through a re-chargeable battery. It will also have a remote. This invention is used in the car on the right side of the driver next to the automatic or five speed gear.
Provisional Patent application No. 60/821,37
Tenzing Kunga, Greenfield, Mass.

[FIG. 1] This view is of the machine in the front half of the car. The machine is placed next to the driver in the passengers section. The two front car doors are seen in the picture. Also seen are the car steerings and the cars electrical outlet. There is a wire that is going to connect the machine to the electrical outlet of the car. This picture can also be seen as a view of the front portion of the car from the top with the machine.

[FIG. 2] This figure shows the different details of the machine. There are two large layers at the top of the machine that are marked Coffee and Tea. These two layers have equal dimensions and they act as large buttons when pressed. The functioning of this machine starts when these two buttons are pressed by hand or by a remote control which will be described in FIG. 4. Below the layers and in the inner portion of the machine you will see a storage space for cold water and next to it towards the left are storage spaces for coffee powder and tea leaves. Further more towards the left you can see storage space for sugar and cream and then below a space for mixing the coffee, cream, sugar, water or/tea, cream, sugar, water. Once this process is completed and the drink is ready for serving it can discard tea bags for which there is a section called Discard Tea Leaves. This part of the machine as seen in FIG. 2 will be a small portion that when pushed gently comes out just like a cd-rom drive of a computer. Above this section is the cup holder and the cup. The drink after being ready in the mixing section will pour 8 oz. of coffee/tea directly on the cup through a small pipe and the pipe opening and thereafter the cup will immerse gradually upwards within easy reach of the driver. This cup can be changed upon individual preference. There are also two manual buttons which can be pressed to block the sugar and cream.

[FIG. 3] This is the view of the machine from the top. You can see the cup and the cup holder and the topmost layers that say COFFEE AND TEA.

[FIG. 4] This is the image of the remote control that can also activate this machine. It is an elongated rectangle that has five buttons. The first one from the top is the power button, the second one to the left is the Coffee button, the third to the right of the Coffee button is the Tea button and the last two buttons in the third row are of the Block Dairy and Block Sugar Buttons.

What is claimed for:

1. This invention will work using electrical technology. It will be automated. This machine will stick or lie on the right side of the driver next to the gear. It will be connected to an electrical outlet in the car. This machine will have a section where you can add water, another four small section that will store coffee powder, tea leaves, sugar and cream. It will also have a cup holder and a cup that automatically emerges upwards for convenient drinking. It will be within easy reach of the driver. There will be two buttons. Once the Tea button is pressed the machine will send cold water that is now hot to a certain other section and then push a tea bag or coffee and a little sugar or cream. If someone does not need sugar or cream they have the option to click another button that blocks the sugar flow or cream flow. The machine will then mix the tea, eliminate the tea bag or tea leaves into another section which can be opened and cleaned. This method would apply for the coffee too.
